(19) United States
(12) Patent Application Publication
(10) Pub. No.: US 2011/0066488 A1
(43) Pub. Date: Mar. 17, 2011

(54) MOBILE AD ROUTING

(75) Inventors: Carl Ludewig, San Rafel, CA (US); James Barnes, Overland Park, KS (US); Dora Potluri, Plano, TX (US); Steve Danzo, Kansas City, MO (US)

(73) Assignee: Ad Infuse, Inc., San Francisco, CA (US)

(21) Appl. No.: 12/562,023

(22) Filed: Sep. 17, 2009

(51) Int. Cl. G06Q 30/00; G06F 3/01

(52) U.S. Cl. 705/14.43; 715/738

(57) ABSTRACT

In various embodiments, a method is described that includes receiving, at one or more computer systems, one or more ad network optimization factors corresponding to a plurality of ad networks registered with the one or more computer systems; analyzing, by the one or more computer systems, logged performance data corresponding to one or more previous ad requests routed to the plurality of ad networks over a predefined period of time; and generating, by the one or more computer systems, an optimal ad network distribution for future ad requests to be routed to the plurality of ad networks based on the analyzed logged performance data and the one or more ad network optimization factors.

### TECHNICAL FIELD

This disclosure relates generally to advertising, and more particularly to systems and methods directed to advertising over mobile devices.

### BACKGROUND

In a manner similar to the internet and television, advertisers are increasingly developing advertisements targeted for viewers of mobile content displayed via mobile devices such as mobile phones and other portable display devices. Indeed, the capabilities and uses of mobile devices have moved beyond voice communications and personal information management applications to a variety of functions including email, web browsing, instant messaging, and social networking (e.g., Myspace, Facebook, etc.). The ability to target ads to specific users or groups of users and to specific content generally increases the relevancy and effectiveness of the advertising. However, management and configuration of ad networks present certain challenges.

### BRIEF DESCRIPTION OF THE DRAWINGS

FIG. 1 illustrates a block diagram of an example computer network environment that includes an example ad management system.

FIG. 2 illustrates a block diagram of a particular computer network environment that includes a particular ad management system.

FIG. 3 illustrates example components or modules of an example master agent of an example ad management system.

FIG. 4 illustrates example components or modules of an example master manager of an example ad management system.

FIG. 5 illustrates an example user interface provided by a master manager of an example ad management system for registering the inventory of a mobile content provider.

FIG. 6 illustrates an example user interface provided by a master manager of an example ad management system for adjusting optimization factors and viewing optimization results.

FIGS. 7A and 7B illustrate example tables illustrating how optimization may be performed.

FIG. 8 illustrates example components of an example computer system.

### DESCRIPTION OF EXAMPLE EMBODIMENTS

This disclosure relates generally to advertising, and more particularly to systems and methods directed to advertising over mobile devices.

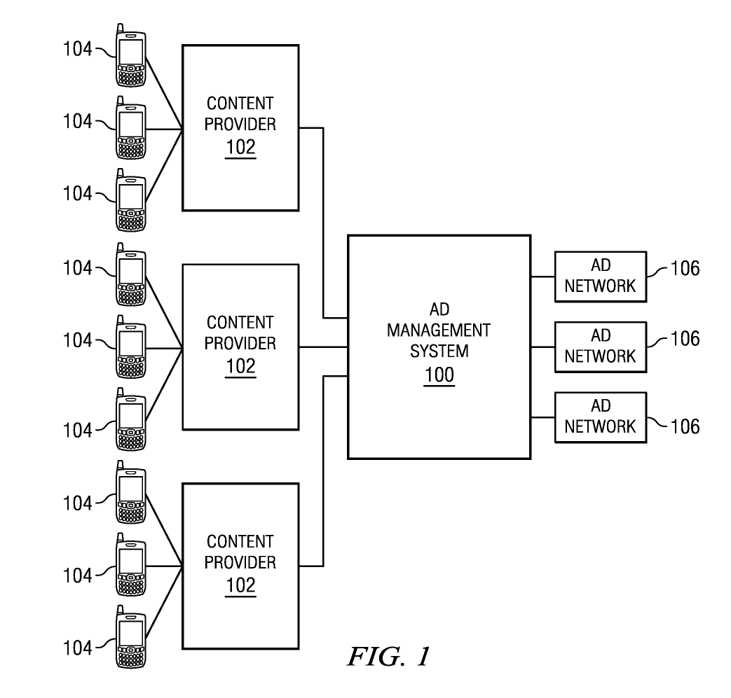

FIG. 1 illustrates a block diagram of a computer network environment that includes an ad management system 100 in accordance with an example embodiment. In particular embodiments, ad management system 100 is generally an ad network management platform that provides an integration and management interface to content providers 102, particularly mobile content providers, desiring to enable advertising within target content provided by the mobile content providers and viewed or viewable on mobile devices 104. In particular embodiments, the advertising is targeted for mobile (e.g., wireless) devices 104 such as, by way of example, mobile or cellular phones, smart phones, personal digital assistants (PDAs), multimedia players/browsers (e.g., the iPOD Touch produced by Apple Inc. of Cupertino, Calif.), and portable gaming devices, among other mobile devices.

In various example embodiments, mobile content providers 102 may include both content publishers/owners (e.g., ESPN or CNN) as well as network service providers/carriers (e.g., AT&T, Verizon, T-Mobile, etc.). By way of example, a content publisher may generally be any company that provides mobile content to mobile consumers, where appropriate. Mobile content (hereinafter also referred to as “content”) may be considered any mobile media (e.g., a web or WAP (Wireless Application Protocol) page) that can be viewed/consumed by mobile consumers, where appropriate. A carrier may generally be any company that provides mobile telephony services, and may also be considered a publisher if the carrier is also a provider of mobile content to the mobile devices 104 of the users/customers the carrier serves. An advertisement (ad) as used herein may be considered content (e.g., text, graphical, video, etc.) that is embedded within existing target mobile content for the consumer to view and interact with via the consumer's mobile device 104. In the following described embodiments, ads may be received from ad networks 106 in response to ad requests embedded within mobile content requested by mobile devices 104. An ad network 106 may generally be a vendor or platform that serves ads from an ad inventory in response to ad requests from content providers 102. However, as noted above, a significant portion of ad requests are not served by ads. An impression is an ad returned by an ad network that is actually placed with the target mobile content displayed to the consumer (e.g., user of the mobile device 104).

In various example embodiments, ad management system 100 facilitates and simplifies the management of multiple ad networks 106, reduces operational costs associated with managing the multiple ad networks 106, optimizes the routing of ad requests to the multiple ad networks 106 potentially in real-time, improves sell-through rates and increases advertising revenue, and facilitates a better user experience for consumers of mobile content (e.g., the users of the mobile devices 104) by introducing consistency and increased relevancy in advertising from multiple ad networks 106. More particularly, ad management system 100 may enable one or more of the following: ad request routing, ad request translation, user profile caching, privacy/customer information protection, inventory management, optimization, and reporting, among other functions. Additionally, although three content providers 102 and three ad networks are shown for illustrative purposes in describing example embodiments, it should be understood that ad management system 100 may serve virtually any number of content providers 102 and route ad requests to virtually any number of ad networks 106.

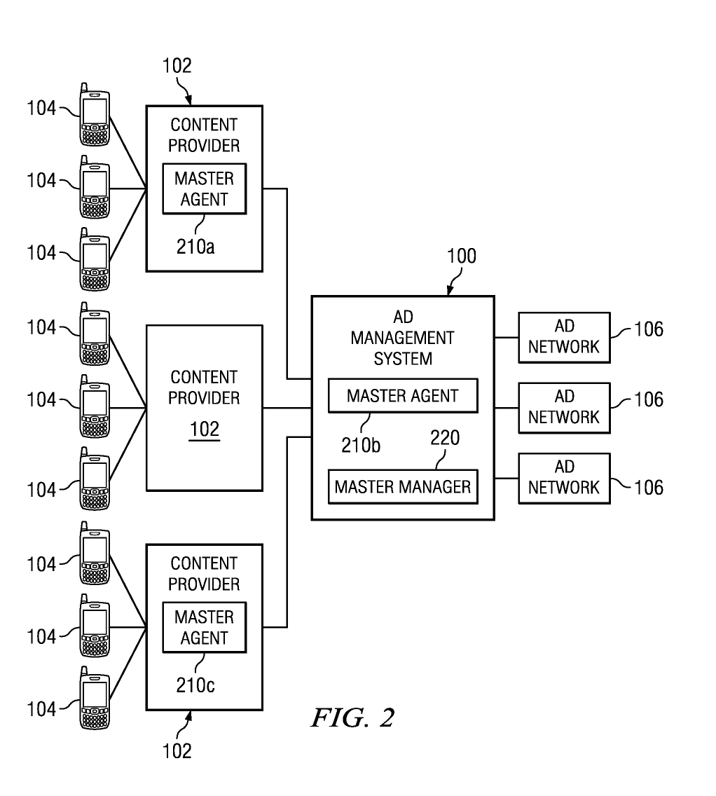

FIG. 2 illustrates a block diagram of a particular computer network environment 200 in accordance with a particular example embodiment. In the illustrated embodiment, ad management system 100 comprises a dual architecture. More particularly, for any given registered mobile content provider 102, ad management system 100 comprises two primary components or modules: master agent 210 and master manager 220. In particular embodiments, this dual architecture promotes increased performance, security, and reliability as well as supporting redundancy and load balancing.

In particular embodiments, each master agent 210 may be installed in a data center within or in communication with a particular mobile content provider 102 or, alternately, master agent 210 may be provided as a service hosted by ad management system 100 at an external location within one or more servers within a central ad service provider or in the cloud. By way of example, master agent 210 may be cloud-hosted in the Amazon Elastic Computing Cloud. In an example embodiment, a cloud-hosted deployment spares the content provider 102 the hardware and software costs associated with internal deployment and may be more rapidly scalable. On the other hand, deployment of master agent 210 within the content provider 102 may be preferred if the content provider has a customer profile database to be used in conjunction with agent profile manager 314 described below. However, in particular embodiments, in either case (installed or hosted), each master agent 210 may be specific to the corresponding content provider 102 it serves. In the illustrated embodiment, master agent 210a is installed at content provider 102a and master agent 210c is installed at content provider 102c, while content provider 102b is served by master agent 210b hosted within ad management system 100.

In particular embodiments, master manager 220 resides in or is hosted by ad management system 100 at an external location within one or more servers within a central ad service provider or in the cloud. By way of example, master agent 210 may be cloud-hosted in the Amazon Elastic Computing Cloud. Furthermore, in particular embodiments, a single master manager 220 may manage each of the master agents 210 corresponding to a particular mobile content provider 102 whether the master agents 210 are hosted or installed at external customer sites corresponding to their respective mobile content providers 102. In one particular embodiment, a single master manager 220 may be configured to manage all of the master agents 210 corresponding to a plurality of mobile content providers 102 (that is, one central master manager 220 may manage all the master agents 210 of a plurality of content providers 102 as opposed to the central ad service provider hosting a master manager application for each mobile content provider 102), while keeping customer information private to each respective customer mobile content provider 102. In an alternate embodiment, a master manager 220 may be installed at an external customer site of a corresponding mobile content provider 102.

In various example embodiments, each master agent 210 and/or master manager 220 may be implemented as an application within one or more general or specific-purpose servers within or in communication with a central ad service provider or content provider 102. In an alternate embodiment, each master agent 210 and/or master manager 220 may be implemented as a separate device that is installed or otherwise coupled with the central ad service provider or content provider 102. Each master manager 220 and corresponding master agents 210 are in communication with one another via one or more wired or wireless networks or network links. By way of example, networks or network links may include one or more packet-based networks, WLAN/WiFi, WiMAX, and Wide Area Networks (WANs). Likewise, master manager 220 and master agents 210 are in communication with a corresponding content provider 102 and one or more ad networks 106 via one or more wired or wireless networks or networks links. Additionally, mobile devices 104 may be in communication with content providers 102 via one or more wired or wireless networks or networks links including, by way of example, a network link utilizing a cellular-based communication infrastructure that includes cellular-based communication protocols such as AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others, as well as any of the networks disclosed above.

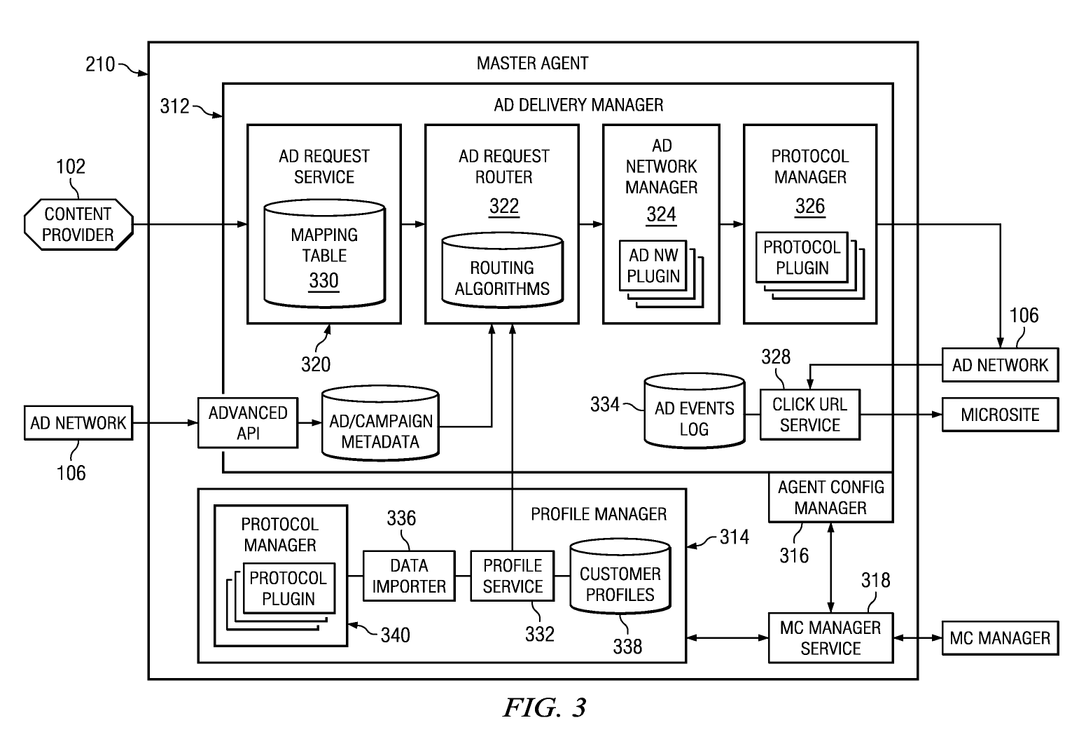

FIG. 3 illustrates example components or modules of master agent 210. In particular embodiments, master agent 210 is configured to handle ad request translation, routing, and proxying functions as will be described in more detail below. In particular embodiments, master agent 210 includes an ad delivery manager 312, profile manager 314, agent configuration manager 316, and master manager service 318. Ad delivery manager 312 includes components and services configured to receive ad requests from content providers 102, apply business rules, and proxy the ad requests to appropriate ad networks 106. Profile manager 314 is configured to cache or store customer profiles of corresponding content providers 102 for use in, by way of example, ad targeting. Agent configuration manager 316 is configured to read local configuration data while also interfacing with master manager 220 to receive remote configuration information from master manager 220. In particular embodiments, agent configuration manager 316 is configured to ensure that real-time configuration requests concerning, by way of example, priority ad networking, are acted upon immediately ensuring that master agent 210 may be tuned dynamically. Master manager service 318 is configured to handle the communication of configuration information sent from master manager 220 to master agent 210 as well as to transmit logged performance data and other information from master agent 210 to master manager 220.

In particular embodiments, ad delivery manager 312 further comprises an ad request service 320, ad network router 322, ad network manager 324, protocol manager 326, and click URL service 328. Ad request service 320 is configured to receive inbound ad requests from a customer mobile content provider 102 and map them to a common internal structure such as, by way of example, a mapping table 330. More particularly, ad request service 320 may be configured to extract parameters from inbound ad requests received from a mobile content provider 102, map the parameters, and to pass the mapped parameters to ad network router 322. Ad request service 320 may also provide “pass through” capability for parameters in ad requests that aren't recognized by a mapping engine within ad request service 320. More particularly, ad request service 320 may pass unrecognized parameters unchanged to ad network router 322.

By way of example and not by way of limitation, parameters found within example ad requests may include the sex, age, occupation, income level, geographic location, demographic, among other information relating to a user of a mobile device from which target content is requested and in which target content the content provider 102 may desire to insert an ad. As a more specific example, suppose an ad request includes a customer parameter “sex” specifying the sex of the user of the target mobile device as male. Also suppose the ad request includes a customer parameter specifying that the user owns a dog. In a particular example embodiment, ad request service 320 recognizes “male” as a value for an ad matching parameter “sex”; however, the parameter “sex” may not be an internal parameter utilized by ad request service 320 while “gender” is an internal parameter utilized by ad request service 320. Ad request service 320 then maps the value “male” to the internal parameter “gender” in the mapping table. This is an example of how ad request service 320 may perform translation or mapping service. Since ad request service 320, in this example, does not recognize the “owns a dog” parameter, ad request service 320 may pass this parameter unchanged to ad network router 322. In a particular embodiment, a separate configuration file (e.g., XML-based) stored for each content provider 102 provides the mapping table used by ad request service 320 to map the parameter/value pairs for the particular content provider 102.

In particular embodiments, ad network router 322 is configured to determine the allocation of outbound ad requests to the ad networks 106 (after translation and filtering of the parameters in the inbound ad requests from the content providers 102 as will be described in more detail below). In an example embodiment, ad network router 320 may be configured to determine the order of ad networks 106 to which ad requests are routed. The determination of which ad requests are routed to which ad networks 106 may be based on ad network prioritization rules or optimization factors (hereinafter referred to as optimization factors) which may be defined by the customer mobile content provider 102 using a user interface provided by master manager 220 as will be described in more detail below. Ad network router 322 may also add an ad network identifier (ID) to each ad request prior to routing the ad request to a particular ad network. By way of example, the ad network ID corresponding to the particular ad network 106 to which the ad request is to be routed may be added to an ad request data object and subsequently passed to ad network manager 324 for mapping to the destination ad network 106.

In particular example embodiments, ad network router 322 may be additionally configured to retrieve cached user/customer profiles corresponding to associated mobile content providers 102. By way of example, a particular customer profile may include attributes and parameters entered by the mobile content provider 102 as well as other configuration information stored for a particular corresponding content provider 102. Such attributes and parameters (e.g., sex, age, demographic, etc.) specify the intended target of the ad to the ad network 106 receiving the ad request so that the ad network can return a more relevant ad. Ad network router 322 may attempt to locate a unique mobile content provider ID in each ad request received from ad request service 320. By way of example, if ad network router 322 finds a mobile content provider ID in a particular ad request, ad network router 322 may then request a customer profile corresponding to the unique ID from profile service 332 within profile manager 314. Ad network router 322 may then add pre-mapped targeting information in the form of attributes or parameters extracted from the user profile to the ad request. In an example embodiment, if an attribute is found in both an inbound ad request and the customer profile of the content provider from which the request was sent, the attribute value in the ad request takes precedence. By way of example, if the attribute in the customer profile specified that the target demographic includes both men and women aged 18-24 but the attribute in the inbound ad request specified men aged 18-24, then the attribute in the inbound ad request would take precedence and the outbound ad request routed to the ad network 106 would request an ad targeted for a man aged 18-24.

In particular example embodiments, ad network router 322 may be additionally configured to capture and log events and/or performance data related to ad requests sent to ad networks 106 and, furthermore, correlate the performance data with the particular ad network it relates to. By way of example, example events may include the routing of an ad request to an ad network 106 or the receipt (or lack thereof) of an ad from an ad network 106 in response to an ad request routed to the ad network. Ad network router 322 may further be configured to log response times, errors, and timeouts, among other event information relating to the events described above. Ad network router 322 may then pass this logged information to master manager service 318 for use in optimization and reporting.

In particular embodiments, ad network manager 324 is configured to translate the ad request data object and package it in an outbound ad request for consumption by the target ad network 106 selected by ad network router 322. In an example embodiment, this may include the insertion of any ad network-specific content ID, if the ad network requires one. By way of example, the ad network-specific content ID may be entered by a particular mobile content provider 102 upon registering the particular ad network 106 with the ad optimization system 100. In particular embodiments, ad network manager 324 is further configured to parse responses from ad networks 106, locate any click URLs (Uniform Resource Locators) in the responses, and substitute the URLs for click proxy services.

In particular embodiments, ad management system 100 captures ad click-through metrics by proxying ad click-throughs from the ad networks 106. In an example embodiment, click URL service 328 utilizes a URL-encoded redirect query to forward ad requests and records click-through events in ad events log 334.

In particular embodiments, profile manager 314 enables mobile content providers 102 who have databases (e.g., storing user data corresponding to users of mobile devices 104) and identifiable users to provide their users with a highly individualized mobile experience. By way of example, a customer profile of a particular mobile content provider 102 may be imported (e.g., asynchronously) into a customer profile data store 338 by data importer 336 and/or profile service 332. In particular embodiments, customer profile data store 338 may be accessed by all of the master agents 210 associated with the mobile content provider 102. Profile service 332 handles queries for profile information from ad delivery manager 312.

Master manager service 318 is primarily configured to interface with master manager 220, handling both outbound communications to master manager 220 (e.g., event/performance data) as well as inbound communications from master manager 220 (e.g., configuration data and application control).

Additionally, while most ad network implementations may utilize HTTP and FTP for transport, some ad networks may not. Protocol managers 326 and 340 provide a means of implementing other protocols and payloads if needed by a content provider 102 or ad network 106.

In particular embodiments, for a given customer mobile content provider 102, master manager 220 is configured to provide/present a graphical user interface (UI) to the mobile content provider 102 as well as configuration and reporting tools for each of the master agents 210 associated with the mobile content provider 102. More particularly, master manager 220 is configured to present a UI through a web portal at a remote computer system or terminal accessible by the mobile content provider 102. By way of example, master manager 220 may be configured to present the UI at the remote computer system or terminal by transmitting UI data in the form of, for example, an HTML (Hyper Text Markup Language) document, to a client application (e.g., a web browser) hosted in the remote computer system or in communication with the terminal. When the client application consumes the UI data transmitted by master manager 220 the client application, in conjunction with an operating system and other elements, renders the UI on a display of the remote computer system or terminal.

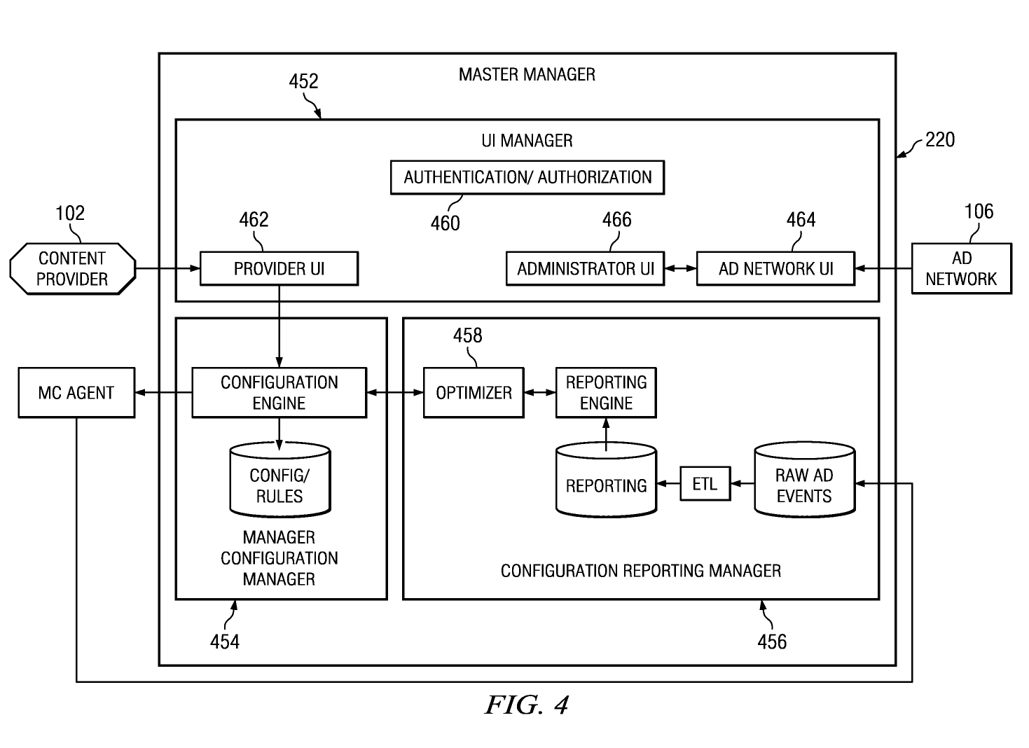

FIG. 4 illustrates more particularly example components or modules of master manager 220. In particular embodiments, master manager 104 includes a UI manager 452, a manager configuration manager 454, a reporting manager 456, and an optimizer 458 (which, in the illustrated embodiment, is within reporting manager 456, although this is not a requirement as optimizer 458 may also reside within manager configuration manager 454 or elsewhere). In particular embodiments, UI manager 452 is configured to provide authentication services and the UIs for a mobile content provider 102 or other user. In particular, UI manager 452 includes an authentication and authorization service 460 as well as a provider UI service 462 for use by a content provider 102. In the illustrated embodiment, UI manager 452 additionally includes an ad network UI service 464 for use by an ad network 106 and an administrator UI service 466 for use by an administrator.

Manager configuration manager 454 is generally configured to create, update, and delete configuration information for master agents 210 and ad networks 106 based on configuration information input, for example, a content provider 102 via a UI provided by provider UI service 462. Manager configuration manager 454 is also configured to provide functions for registering inventory and configuring business rules for ad networks 106. By way of example, a particular mobile content provider 102, using an interface provided by provider UI service 462, may enter configuration information to, by way of example, register it's content, tag it's content, configure ad networks, enable/disable a particular ad network, as well as set priority ordering rules for routing ad requests to the ad networks 106.

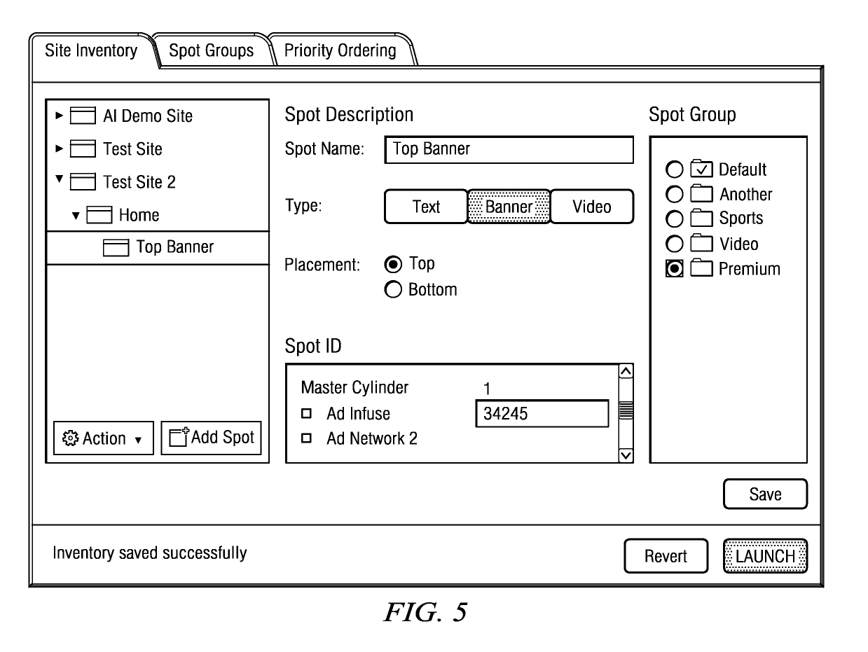

FIG. 5 illustrates an example user interface provided by a master manager 220 (particularly provider UI service 462) to a remote computer system or terminal for use by a mobile content provider 102 (or more specifically an administrator or other member of representative of the content provider, hereinafter also referred to as content provider) in registering the content provider's inventory. Inventory may be defined as the content that is available for ads to be served into. In a particular example embodiment, the inventory of a particular content provider 102 may be hierarchically organized into sites (e.g., web or WAP), pages, spots, and spot groups, all registered/input via the user interface provided by master manager 220. Sites are collections of related pages belonging, for example, to a single content publisher. A page may contain one or more spots. Each spot represents a specific location on a page (e.g., top or bottom for still graphics, and pre-, mid-, or post-roll for video) at which an ad may be inserted. By way of example, if a particular content provider 102 has 5 pages each including 2 spots and each of which is generally viewed 1000 times a month, then the inventory available for ads would be 5*2*1000=10000. A group of spots or “spot group” is a collection of spots, not necessarily within the same page or even the same site. More particularly, the spots of a given spot group may share certain features or may be intended for ads directed to a particular target audience.

In particular embodiments, during the registration of the content, each registered spot is assigned a unique spot ID (e.g., unique to the particular spot and particular content provider 102 registering the content). A spot's corresponding spot ID is included with each ad request sent by a content provider 210 requesting an ad for that spot allowing ad management system 100 to identify the content and content provider 102 making the ad request. This spot ID may be inserted into an ad tag placed in the content page. Using the user interface provided by the corresponding master manager 220, the content provider 102 may then assign selected ad spots to spot groups according to any desired criteria. By way of example, example spot groups may include interior spots, home page spots, spots reserved for sponsors, premium spots, etc.

The user interface may also provide entry boxes enabling the content provider 102 to enter ad network-specific content IDs. By way of example, some ad networks 106 registered with ad management system 100 may require such ad network-specific IDs that identify the corresponding ad network to which an ad request is routed. Ad network router 322 passes these ad network-specific IDs to the ad network 106 to which the ad request from a particular spot is routed.

After a particular content provider 102 registers its inventory and obtains spot IDs for it's spots, the content provider may then, using the user interface provided by master manager 220, tag it's content such that when particular content is requested by a mobile device 104, an ad request is transmitted to ad management system 100. In one implementation, the tag is implemented with a server-side request from the publisher to the ad router made when the mobile page is being constructed. When the tagged content is requested by a mobile device 104, an ad request is transmitted to the ad management system 100, which then routes a subsequent ad request to a particular ad network (e.g., after analyzing, translating, and/or otherwise modifying the inbound ad request). In particular embodiments, the spots of a particular mobile content provider 102 need only be tagged once.

After registering and tagging the content, the content provider 102 may then configure the ad networks 106 content provider 102 desires to employ to serve its ad requests from spots in particular spot groups. Utilizing the user interface provided by master manager 220, content provider 102 may select a particular ad network 106 and enter a partner ID provided to the content provider by the ad network as well as other configuration information.

After configuring the selected ad networks 106, the content provider 102 may then prioritize or otherwise select the routing distribution of ad requests for the particular spot group to the selected ad networks 106. In other words, the content provider 102 may specify how ad network router 322 routes ad requests from spots in a given spot group to the corresponding set of ad networks 106 registered to serve the spot group.

By way of example, the following are example prioritization schemes: percent allocation, fixed order, round robin (e.g., ad requests are allocated equally among the ad networks selected), best network response, relevancy and revenue. In an example embodiment, ad network router 322 routes a given ad request to the ad network 106 having the highest score or ranking according to the prioritization algorithm/scheme selected for the spot group corresponding to the spot for which an ad request is made. By applying different prioritization algorithms to different ad spots, the content provider 102 can optimize the routing of ad requests for various content sectors regardless of those sectors' technical, topical, or physical relationships.

By way of example, in the percent allocation scheme, the content provider 102 chooses and enters the percentage of its ad requests that will go to each ad network 106 serving the spot group (e.g., 50% to a first ad network, 35% to a second ad network, and 15% to a third ad network). In the fixed order scheme, the ad networks selected for the particular spot group are scored or ranked among themselves and an ad request is first routed to the ad network having the highest ranking or score. In the best network response scheme, the ad network with the fastest ad return response time over a customer-defined or otherwise predefined period of time receives the ad requests. In the relevancy and revenue scheme, each ad request is routed to the ad network having the most relevant ad, e.g., defined by the targeting criteria (e.g., demographic) defined in the parameters/attributes in the ad request, and/or the best-paying ad, e.g., defined by CPM or CPC.

In particular embodiments, ad networks 106 may occasionally or periodically transmit campaign feeds to content providers 102 and/or ad management system 100, e.g., via master agent 210 or master manager 220, to aid optimizer 458 in routing ads to ad networks to maximize revenue and/or relevancy, for example, or to otherwise provide additional information to ad management system 100. By way of example, an ad network 106 may transmit a campaign feed in the form of an Extensible Markup Language (XML) document that includes metadata or other additional information such as information concerning a particular advertiser, advertiser ad campaign, target demographic, or value of a particular ad (e.g., in CPM or CPC). In one example embodiment, the campaign feed is made available by the ad network 106 to a content provider 102 via a URL. In one particular embodiment, ad management system 100 also monitors the URL for updates to the campaign feed or for new campaign feeds. The following is a sample campaign feed in the form of an XML document:

<?xml version=“1.0”?>
<mc version=“1.0”>

<network>

<name>Ad Infuse</name>
<link>http://www.adinfuse.com</link>
<description>The Ad Infuse mobile advertising
network</description>
<language>en-us</language>
<pubDate>Wed, 04 Feb 2009 17:00:00 GMT</pubDate>
<administrator>support@adinfuse.com</administrator>
<ttl>60</ttl>
<ad>

<name>Example Ad</name>
<advertiser>Brand X</advertiser>
<campaign>Campaign 1</campaign>
<id>abcd1234</id>
<type>banner</type>
<startDate>Tue, 03 Feb 2009 00:00:00 GMT</startDate>
<endDate>Tue, 24 Feb 2009 23:59:59 GMT</endDate>
<cpm>20.00 USD</cpm>
<age>25-34</age>
<sex>M></sex>
<cat>Sport</cat>

</ad>
<ad>

<name>Example Ad 2</name>
<id>XXZ-123</id>
<type>text</type>
<startDate>Wed, 04 Feb 2009 00:00:00 GMT</startDate>
<endDate>Wed, 25 Feb 2009 23:59:59 GMT</endDate>
<cpc>0.50 USD</cpc>
<cat>Arts</cat>
<co>US</co>
<co>GB</co>

</ad>
<ad>

<name>Example Ad 3</name>
<advertiser>Brand X</advertiser>
<campaign>Spring Drive</campaign>
<id>012345</id>
<type>banner</type>
<startDate>Tues, 04 Feb 2009 00:00:00 GMT</startDate>
<endDate>Fri, 06 Feb 2009 23:59:59 GMT</endDate>
<cpm>15.00 USD</cpm>

</ad>

</network>

</mc>

where “name” specifies the name of the mobile ad network or the name of the advertisement dependent on whether the name field is within the “network” or “ad” portion of the document; “link” specifies the URL to the network's web site; “description” specifies a phrase or sentence describing the network; “language” specifies the language of the region that the ad network serves; “pubDate” specifies the date and time the feed was published; “ttl” specifies the “time to live” of the feed (e.g., the number of minutes the feed can be cached before refreshing; “administrator” specifies the email address of the party responsible for maintaining and supporting the feed; “advertiser” specifies the name of the advertiser; “campaign” specifies the name of the advertising campaign; “id” represents a unique identifier for the advertisement; “type” specifies the media type of the advertisement (e.g., text, banner, or video); “startDate” specifies the date and time the ad will become available; and “endDate” specifies the date and time the ad will no longer be available. Other elements found in the campaign feed may include the CPM, CPC, cat (e.g., target category), cid (the spot ID), age (age range of the target demographic), sex (gender of the target demographic), race (ethnicity of the target demographic), ed (education level of the target demographic, hhs (household size of the target demographic), inc (income level of the target demographic), and ints (area of interest of the target demographic), among others.

In particular embodiments, reporting manager 456 is configured to retrieve event logs, including performance data logged for each of the ad networks 106, from master agents 210 and to provide a reporting user interface for querying and viewing logged data by a mobile content provider 102 or other user. Reporting manager 456 may also be configured to generate general as well as customer or user-specific reports based on the logged data.

Optimizer 458, in particular embodiments, analyzes logged data (e.g., performance data) which may be retrieved from reporting manager 456 to provide modeling of the performance data over a predefined period of time on a per-ad network basis, estimate future scenarios based on the modeled data, and to enable a customer mobile content provider 102 to optimize their business rules based on one or more optimization factors for achieving optimal performance. In the illustrated embodiment, optimizer couples a reporting engine (e.g., software and/or hardware module) within reporting manager 456 to a configuration engine (e.g., software and/or hardware module) within manager configuration manager 454. In a particular example embodiment, optimizer 458 analyzes or models logged performance data corresponding to each of the ad networks 106 over a specified period of time and determines optimum ad network routing settings for specific, content provider-defined ad spot groups for future ad requests.

By way of example, the logged performance data that optimizer 458 may analyze for each ad network 106 may include one or more of a sell-through rate (STR), e.g., the ratio of the number ad impressions served by each ad network to the number of ads requested from the ad network in the analyzed period; a click-through rate (CTR), e.g., the ratio of ad click-throughs to the number of ad impressions served in the analyzed period; effective cost per mille (eCPM), e.g., the actual inventory earnings per 1000 ad impressions served multiplied by 1000 in the analyzed period; response time, e.g., the average amount of time it takes a particular ad network to deliver an ad in response to an ad request in the analyzed period of time; revenue, e.g., the revenue earned from ad requests routed to each ad network in the analyzed period of time; relevancy, e.g., the ratio of ad targeting criteria in the ad requests to the known attributes of the ads actually served by each ad network in the analyzed period of time; as well as other performance data such as errors and timeouts (e.g., when an ad network does not return an ad within a predetermined time-out period). Similarly, by way of example, optimization factors may include STR, CTR, eCPM, response time, revenue, and relevancy, as well as any other factors related to performance data.

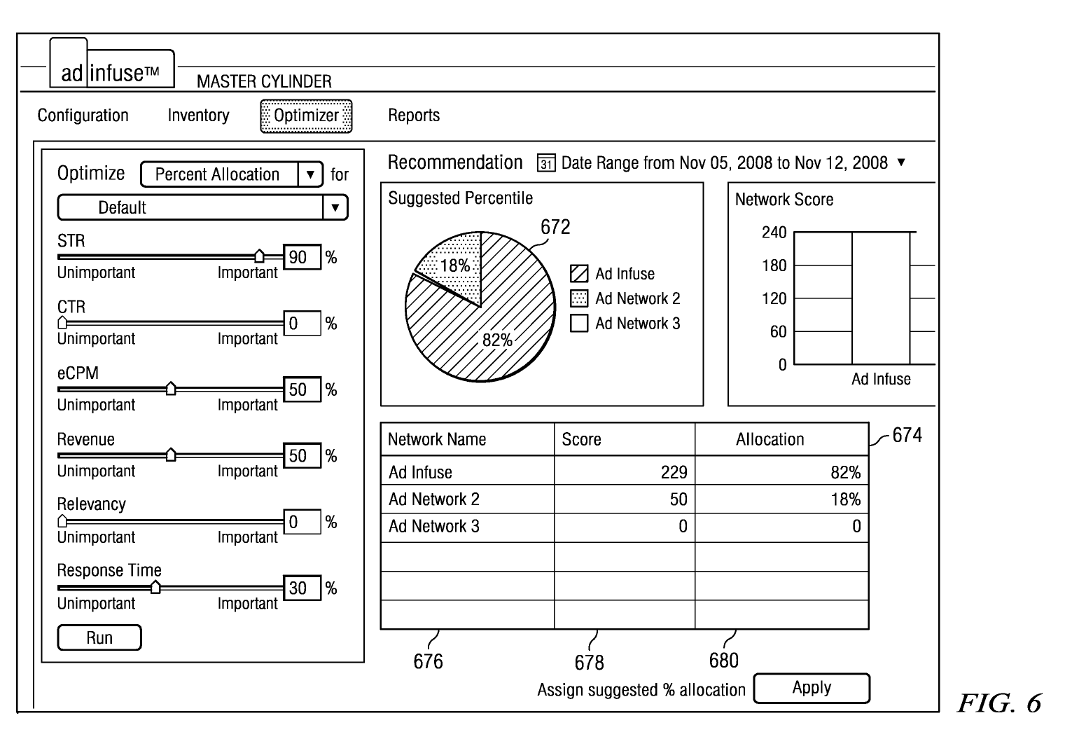

As illustrated in FIG. 6, a user interface provided by master manager 220 enables a content provider 102 to enter optimization factors for selected spot groups. In particular embodiments, optimizer 458 analyzes the corresponding logged performance data corresponding to the optimization factors for each of the ad networks 106 serving ad requests for a particular spot group (or groups). In particular embodiments, master manager 220 further enables, through a user interface provided by master manager 220, a content provider 102 to assign relative weightings to various optimization factors (e.g., CTR, STR, eCPM, revenue, relevancy, response time, etc.) and also to analyze the performance of the corresponding ad networks 106 for each spot group over a configurable period of time (e.g., yesterday, Monday of last week, last week, last month, December of last year, etc.). By way of example, the user interface provided by master manager 220 may enable the content provider 102 to enter a start and end date/time defining a period of time over which optimizer 458 analyzes logged performance data corresponding to selected ad networks 106. In the illustrated embodiment, the user interface includes sliders (or slider bars) 670 that the content provider 102 may use to adjust the weight (e.g., importance) of each selected optimization factor for a particular spot group.

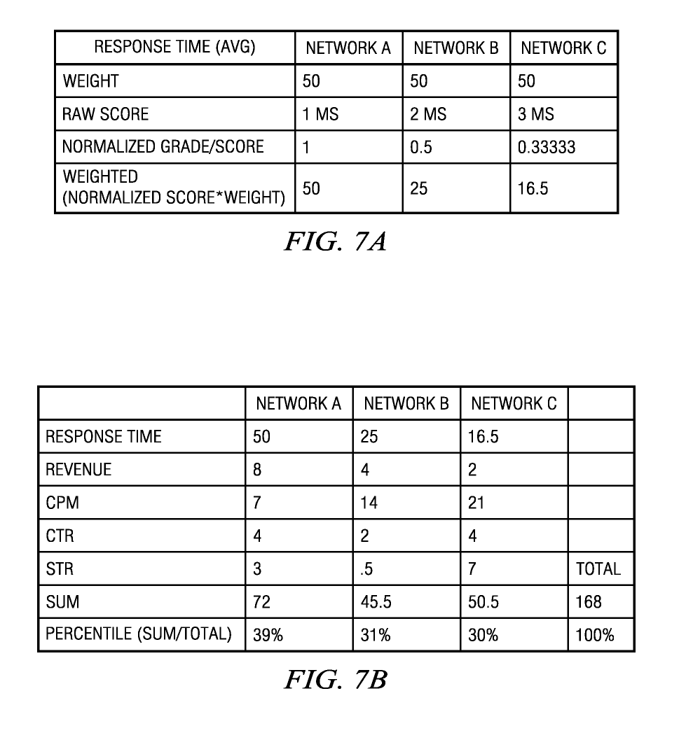

In one example embodiment, optimizer 458, for each ad network 106 serving the spot group, first normalizes the performance data logged in the specified period of time. By way of example, suppose there are three ad networks: Network A, network B, and network C, as illustrated in the response time table shown in FIG. 7A. Furthermore, suppose that Network A has an average response time of 1 millisecond (ms), Network B has an average response time of 2 ms, and network C has an average response time of 3 ms as shown in the table. Also suppose that the optimization factor for response time has a weighting factor of 50. Optimizer then generates a normalized grade or score for each optimization factor based on the normalized logged performance data. By way of example, Network A would receive a normalized grade of 1 (because it has the best, i.e., least latency; note the best performance may always be given a normalized score of 1), Network B would receive a normalized grade of 0.5 (1 ms/2 ms=0.5), and Network C would receive a normalized grade of 0.33333 (⅓≈0.33333), as shown in FIG. 7A. Optimizer 458 then generates a weighted score for each optimization factor based on the normalized grade. By way of example, a weighted score may be generated by multiplying the normalized grade by the weighting factor for the corresponding optimization factor. The weighted scores for all the ad network optimization factors are then summed. By way of example, FIG. 7B shows a table showing example weighted scores for a plurality of optimization factors for each of the ad Networks A, B, and C, as well as the summed weighted scores for each ad network. In a particular embodiment, optimizer 458 then assigns a percentile ranking for the ad network based on the summed weighted scores. By way of example, the percentile ranking for Network A would be 39%, Network B would be 31%, and Network C would b 30% in this example. The percentile ranking may represent the optimal percent allocation for future ad requests (if the ad networks behave in the same way as they did during the specified period of time). The percentile rankings may also be translating into a general ranking (e.g., 1, 2, 3 . . . ).

In particular embodiments, optimizer 458 then generates a recommendation presented via the user interface as to how to allocate or prioritize the routing of ad requests to the ad networks 106 to achieve optimal results according to the weighted optimization factors entered by the content provider 102. By way of example, in the illustrated embodiment, the user interface includes pie chart 672, which illustrates an example recommended percentage allocation or distribution of ad requests for use in a percent allocation prioritization scheme. The user interface may also include table 674 which may include three columns: ad network column 676, which lists the ad networks, score column 678, which lists the corresponding scores (e.g., summed weighted scores), and allocation column 680, which, for example, may lists the corresponding percent allocations (in the illustrated embodiment) for use in a percent allocation scheme or rankings (e.g., 1, 2, 3, . . . ) for use in, for example, a fixed order prioritization scheme.

In some embodiments, the content provider 102 may then adjust the prioritization scheme in accordance with the recommendation from the optimizer 458. By way of example, the content provider may change the percentages in a percent allocation scheme or change the rankings in a fixed order prioritization scheme. In an alternate embodiment, optimizer 458 may automatically set or change the percentages for a percent allocation scheme or the ranking for a fixed order scheme without further input by the content provider. More particularly, optimizer 458 may periodically re-optimize (e.g., every second, minute, hour, day, week, or month, etc.) the allocation based on newly received data in the predetermined period of analysis time. In this way, optimizer 458 may automatically optimize in real-time based on logged performance data. Furthermore, as described above, optimizer 458 may additionally automatically re-optimize the allocation based on campaign feeds received in real-time alternately or in addition to logged performance data. By way of example, if an ad network 106 starts delivering a high-paying ad (which may be determined from a campaign feed received from the ad network, for example), optimizer 458 may re-allocate the routing of ads to preferentially send more requests to that ad network for that ad. Once the high-paying ad is no longer requestable (e.g., the campaign is over) or the price of the ad declines, the optimizer 458 may then automatically re-allocate the routing of ads again. In this way, ad management system 100 may dynamically and automatically, re-allocate inventory to, for example, increase revenue and/or relevancy, without human intervention.

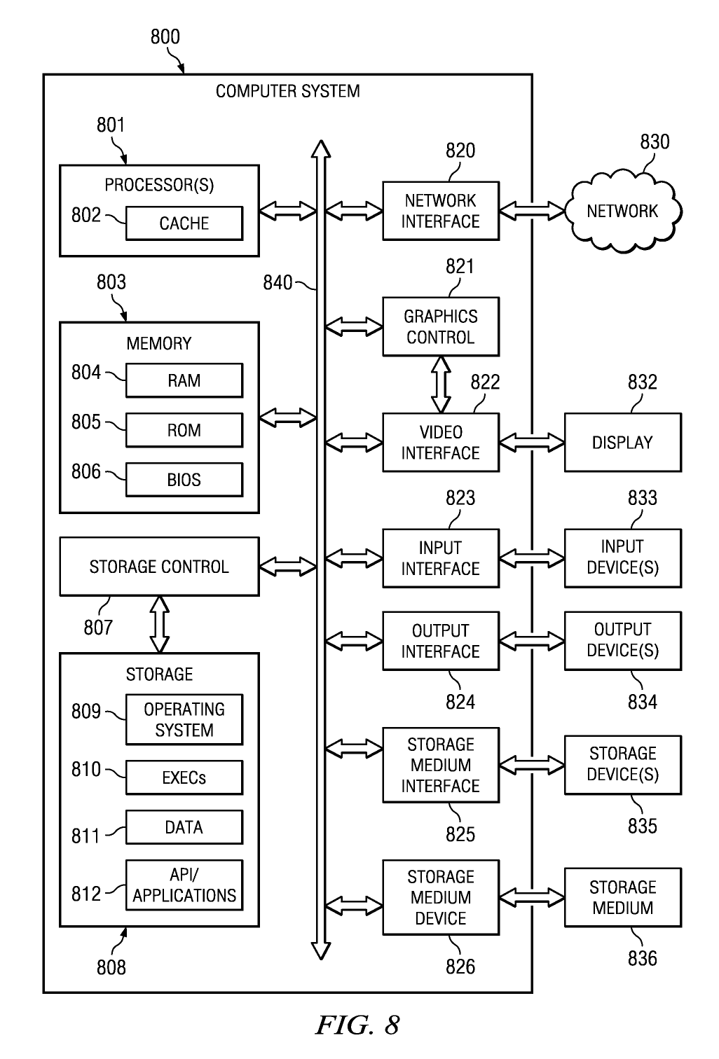

As described above, ad management system 100 may actually include one or more hardware, firmware, and software components residing at one or more computer servers or systems (hereinafter referred to as computer systems). Software components of ad management system 100 may be at one or more of the same computer systems. FIG. 8 illustrates an example computer system 800. Ad management system 100 may include software components at one or more computer systems, which may be similar to example computer system 800. Particular embodiments may implement various functions of ad management system 100 as hardware, software, or a combination of hardware and software. As an example and not by way of limitation, one or more computer systems may execute particular logic or software to perform one or more steps of one or more processes described or illustrated with respect to ad management system 100. One or more of the computer systems may be unitary or distributed, spanning multiple computer systems or multiple datacenters, where appropriate. The present disclosure contemplates any suitable computer system. Herein, reference to logic may encompass software, and vice versa, where appropriate. Reference to software may encompass one or more computer programs, and vice versa, where appropriate. Reference to software may encompass data, instructions, or both, and vice versa, where appropriate. Similarly, reference to data may encompass instructions, and vice versa, where appropriate.

One or more tangible computer-readable media may store or otherwise embody software implementing particular embodiments. A tangible computer-readable medium may be any tangible medium capable of carrying, communicating, containing, holding, maintaining, propagating, retaining, storing, transmitting, transporting, or otherwise embodying software, where appropriate. A tangible computer-readable medium may be a biological, chemical, electronic, electromagnetic, infrared, magnetic, optical, quantum, or other suitable medium or a combination of two or more such media, where appropriate. A tangible computer-readable medium may include one or more nanometer-scale components or otherwise embody nanometer-scale design or fabrication. Example tangible computer-readable media include, but are not limited to, application-specific integrated circuits (ASICs), compact discs (CDs), field-programmable gate arrays (FPGAs), floppy disks, floptical disks, hard disks, holographic storage devices, magnetic tape, caches, programmable logic devices (PLDs), random-access memory (RAM) devices, read-only memory (ROM) devices, semiconductor memory devices, and other suitable computer-readable media.

Software implementing particular embodiments may be written in any suitable programming language (which may be procedural or object oriented) or combination of programming languages, where appropriate. Any suitable type of computer system (such as a single- or multiple-processor computer system) or systems may execute software implementing particular embodiments, where appropriate. A general-purpose or specific-purpose computer system may execute software implementing particular embodiments, where appropriate.

The components in FIG. 8 are examples only and do not limit the scope of use or functionality of any hardware, software, embedded logic component, or a combination of two or more such components implementing particular embodiments. Computer system 800 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers. Computer system 800 may include a display 832, one or more input devices 833 (which may, for example, include a keypad, a keyboard, a mouse, a stylus, etc.), one or more output devices 834, one or more storage devices 835, and various tangible storage media 836.

Bus 840 connects a wide variety of subsystems. Herein, reference to a bus may encompass one or more digital signal lines serving a common function, where appropriate. Bus 840 may be any of several types of bus structures including a memory bus, a peripheral bus, or a local bus using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, and an Accelerated Graphics Port (AGP) bus.

Processor(s) 801 (or central processing unit(s) (CPU(s))) optionally contains a cache memory unit 802 for temporary local storage of instructions, data, or computer addresses. Processor(s) 801 are coupled to tangible storage devices including memory 803. Memory 803 may include random access memory (RAM) 804 and read-only memory (ROM) 805. ROM 805 may act to communicate data and instructions unidirectionally to processor(s) 801, and RAM 804 may act to communicate data and instructions bidirectionally with processor(s) 801. ROM 805 and RAM 804 may include any suitable tangible computer-readable media described below. Fixed storage 808 is connected bidirectionally to processor(s) 201, optionally through storage control unit 807. Fixed storage 808 provides additional data storage capacity and may also include any suitable tangible computer-readable media described. Storage 808 may be used to store operating system 809, EXECs 810, data 811, application programs 812, and the like. Typically, storage 808 is a secondary storage medium (such as a hard disk) that is slower than primary storage. Information in storage 808 may, in appropriate cases, be incorporated as virtual memory in memory 803.

Processor(s) 801 is connected to multiple interfaces, such as graphics control 821, video interface 822, input interface 823, output interface 824, storage interface 825, and storage medium interface 826. These interfaces are in turn connected to appropriate devices, as may be illustrated. In general, an input/output (I/O) device may be a video display, a track ball, a mouse, a keyboard, a microphone, a touch-sensitive display, a transducer card reader, a magnetic- or paper-tape reader, a tablet, a stylus, a voice or handwriting recognizer, a biometrics reader, another computer system, or other suitable I/O device or a combination of two or more such I/O devices. Processor(s) 801 may connect to another computer system or to telecommunications network 830 through network interface 820. With network interface 820, CPU 801 may communicate with network 830 in the course of performing one or more steps of one or more processes described or illustrated herein, according to particular needs. Moreover, one or more steps of one or more processes described or illustrated herein may execute solely at CPU 801. In addition or as an alternative, one or more steps of one or more processes described or illustrated herein may execute at multiple CPUs 801 that are remote from each other across network 830.

In particular embodiments, when computer system 800 is connected to network 830, computer system 800 may communicate with other devices connected to network 830. Communications to and from computer system 800 may be sent through network interface 820. For example, network interface 820 may receive incoming communications (such as requests or responses from other devices) in the form of one or more packets (such as Internet Protocol (IP) packets) from network 830 and computer system 800 may store the incoming communications in memory 803 for processing. Computer system 800 may similarly store outgoing communications (such as requests or responses to other devices) in the form of one or more packets in memory 803 and communicated to network 830 from network interface 820. Processor(s) 801 may access these communication packets stored in memory 803 for processing.

Computer system 800 may provide functionality as a result of processor(s) 801 executing software embodied in one or more tangible computer-readable storage media, such as memory 803, storage 808, storage devices 835, and/or storage medium 836. The computer-readable media may store software that implements particular embodiments, and processor(s) 801 may execute the software. Memory 803 may read the software from one or more other computer-readable media (such as mass storage device(s) 835, 836) or from one or more other sources through a suitable interface, such as network interface 820. The software may cause processor(s) 801 to carry out one or more processes or one or more steps of one or more processes described or illustrated herein. Carrying out such processes or steps may include defining data structures stored in memory 803 and modifying the data structures as directed by the software. In addition or as an alternative, computer system 800 may provide functionality as a result of logic hardwired or otherwise embodied in a circuit, which may operate in place of or together with software to execute one or more processes or one or more steps of one or more processes described or illustrated herein. Herein, reference to software may encompass logic, and vice versa, where appropriate. Moreover, reference to a computer-readable medium may encompass a circuit (such as an IC) storing software for execution, a circuit embodying logic for execution, or both, where appropriate. The present disclosure encompasses any suitable combination of hardware, software, or both.

The present disclosure encompasses all changes, substitutions, variations, alterations, and modifications to the example embodiments described herein that a person having ordinary skill in the art would comprehend. Similarly, where appropriate, the appended claims encompass all changes, substitutions, variations, alterations, and modifications to the example embodiments described herein that a person having ordinary skill in the art would comprehend.

What is claimed is:

1. A method comprising:
receiving, at one or more computer systems, one or more ad network optimization factors corresponding to a plurality of ad networks registered with the one or more computer systems;
analyzing, by the one or more computer systems, logged performance data corresponding to one or more previous ad requests routed to the plurality of ad networks over a predefined period of time; and
generating, by the one or more computer systems, an optimal ad network distribution for future ad requests to be routed to the plurality of ad networks based on the analyzed logged performance data and the one or more ad network optimization factors.

2. The method of claim 1, further comprising presenting, by the one or more computer systems, a user interface to a user, wherein the user is a content publisher or network service provider, and wherein the one or more ad network optimization factors are input by the user using the user interface.

3. The method of claim 1, wherein the one or more optimization factors comprise one or more of sell-through rates, click-through rates, effective cost per mille, response time, timeouts, errors, revenue, and relevancy.

4. The method of claim 1, wherein the logged performance data comprises one or more of sell-through rates, click-through rates, effective cost per mille, response time, timeouts, errors, revenue, and relevancy corresponding to ad requests routed to the plurality of ad networks.

5. The method of claim 1, further comprising logging, by the one or more computer systems, performance data corresponding to ad requests routed by the one or more computer systems to the plurality of ad networks.

6. The method of claim 1, wherein generating the optimal ad network distribution comprises ranking the plurality of ad networks according to their corresponding percentile rankings.

7. The method of claim 6, wherein ranking the plurality of ad networks according to their corresponding percentile rankings comprises, for each of the plurality of ad networks:
normalizing the logged performance data;
generating a normalized grade for each optimization factor based on the normalized logged performance data;
generating a weighted score for each optimization factor based on the normalized grade;
summing the weighted scores for one or more of the ad network optimization factors; and
assigning a percentile ranking for the ad network based on the summed weighted scores;
wherein the percentile rankings of the plurality of ad networks define the optimal ad network distribution.

8. The method of claim 7, wherein generating a weighted score comprises multiplying the normalized grade by a weighting factor for the corresponding optimization factor.

9. The method of claim 6, wherein the one or more computer systems route ad requests to the plurality of ad networks based on a fixed-order prioritization scheme, the method further comprising:
receiving an ad request;
routing the ad request to the ad network corresponding to a highest percentile ranking.

10. The method of claim 6, wherein the one or more computer systems route ad requests to the plurality of ad networks based on percent allocation scheme, and wherein generating the optimal ad network distribution comprises allocating a percentage of ad requests to be routed to each of the plurality of ad networks, method further comprising:
receiving one or more ad requests;
routing the one or more ad requests to the plurality of ad networks based on the allocated percentages of ad requests to be routed to each of the plurality of ad networks.

11. The method of claim 6, further comprising, if an ad isn't received from the ad network having a current highest percentile ranking within a predetermined individual timeout period, routing the ad request to a next ad network, the next ad network having a next highest percentile ranking, the next ad network temporarily becoming the ad network with the current highest percentile ranking.

12. The method of claim 11, further comprising repeating the method of claim 11 until a predetermined global timeout period ends.

13. The method of claim 1, wherein generating the optimal ad network distribution comprises automatically and dynamically generating the optimal ad network distribution without human intervention.

14. The method of claim 1, wherein each ad request is for an ad to be inserted into target content of a particular Web or WAP site, each site comprising one or more corresponding pages, each page comprising one or more spots for displaying an ad, wherein ones of the spots are grouped into spot groups, and wherein the one or more optimization factors are tailored for a particular spot group.

15. A system comprising:
one or more processors; and
logic encoded in one or more computer-readable tangible storage media that, when executed by the one or more processors, is operable to:
receive one or more ad network optimization factors corresponding to a plurality of ad networks registered with the one or more computer systems;
analyze logged performance data corresponding to one or more previous ad requests routed to the plurality of ad networks over a predefined period of time; and
generate an optimal ad network distribution for future ad requests to be routed to the plurality of ad networks based on the analyzed logged performance data and the one or more ad network optimization factors.

16. The system of claim 15, wherein the logic is further operable to present a user interface to a user, wherein the user is a content publisher or network service provider, and wherein the one or more ad network optimization factors are input by the user using the user interface.

17. The system of claim 15, wherein the logic is further operable to log performance data corresponding to ad requests routed by the system to the plurality of ad networks.

18. The system of claim 15, wherein the logic operable to generate the optimal ad network distribution comprises logic operable to rank the plurality of ad networks according to their corresponding percentile rankings.

19. The system of claim 18, wherein the logic operable to rank the plurality of ad networks according to their corresponding percentile rankings comprises logic operable to, for each of the plurality of ad networks:
normalize the logged performance data;
generate a normalized grade for each optimization factor based on the normalized logged performance data;
generate a weighted score for each optimization factor based on the normalized grade;
sum the weighted scores for one or more of the ad network optimization factors; and
assign a percentile ranking for the ad network based on the summed weighted scores;
wherein the percentile rankings of the plurality of ad networks define the optimal ad network distribution.

20. The system of claim 19, wherein the logic operable to generate a weighted score comprises logic operable to multiply the normalized grade by a weighting factor for the corresponding optimization factor.

21. The system of claim 18, wherein the logic is operable to route ad requests to the plurality of ad networks based on a fixed-order prioritization scheme, wherein the logic is further operable to:
receive an ad request; and
route the ad request to the ad network corresponding to a highest percentile ranking.

22. The system of claim 18, wherein the logic is operable to route ad requests to the plurality of ad networks based on percent allocation scheme, and wherein the logic operable to generate the optimal ad network distribution comprises logic operable to allocate a percentage of ad requests to be routed to each of the plurality of ad networks, wherein the logic is further operable to:
receive one or more ad requests;
route the one or more ad requests to the plurality of ad networks based on the allocated percentages of ad requests to be routed to each of the plurality of ad networks.

23. The system of claim 15, the logic operable to generate the optimal ad network distribution comprises logic operable to automatically and dynamically generate the optimal ad network distribution without human intervention.

24. The system of claim 15, wherein each ad request is for an ad to be inserted into target content of a particular Web or WAP site, each site comprising one or more corresponding pages, each page comprising one or more spots for displaying an ad, wherein ones of the spots are grouped into spot groups, and wherein the one or more optimization factors are tailored for a particular spot group.

25. One or more computer-readable tangible storage media encoding software that is operable when executed to:
receive one or more ad network optimization factors corresponding to a plurality of ad networks registered with the one or more computer systems;
analyze logged performance data corresponding to one or more previous ad requests routed to the plurality of ad networks over a predefined period of time; and
generate an optimal ad network distribution for future ad requests to be routed to the plurality of ad networks based on the analyzed logged performance data and the one or more ad network optimization factors.

26. The media of claim 25, wherein the software is further operable to present a user interface to a user, wherein the user is a content publisher or network service provider, and wherein the one or more ad network optimization factors are input by the user using the user interface.

27. The media of claim 25, wherein the software is further operable to log performance data corresponding to ad requests routed by the system to the plurality of ad networks.

28. The media of claim 25, wherein the software operable to generate the optimal ad network distribution comprises software operable to rank the plurality of ad networks according to their corresponding percentile rankings.

29. The media of claim 28, wherein the software operable to rank the plurality of ad networks according to their corresponding percentile rankings comprises software operable to, for each of the plurality of ad networks:
normalize the logged performance data;
generate a normalized grade for each optimization factor based on the normalized logged performance data;
generate a weighted score for each optimization factor based on the normalized grade;
sum the weighted scores for one or more of the ad network optimization factors; and
assign a percentile ranking for the ad network based on the summed weighted scores;
wherein the percentile rankings of the plurality of ad networks define the optimal ad network distribution.

30. The media of claim 29, wherein the software operable to generate a weighted score comprises software operable to multiply the normalized grade by a weighting factor for the corresponding optimization factor.

31. The media of claim 28, wherein the software is operable to route ad requests to the plurality of ad networks based on a fixed-order prioritization scheme, wherein the software is further operable to:
receive an ad request; and
route the ad request to the ad network corresponding to a highest percentile ranking.

32. The media of claim 28, wherein the software is operable to route ad requests to the plurality of ad networks based on percent allocation scheme, and wherein the software operable to generate the optimal ad network distribution comprises logic operable to allocate a percentage of ad requests to be routed to each of the plurality of ad networks, wherein the software is further operable to:
receive one or more ad requests;
route the one or more ad requests to the plurality of ad networks based on the allocated percentages of ad requests to be routed to each of the plurality of ad networks.

33. The media of claim 25, wherein the software operable to generate the optimal ad network distribution comprises software operable to automatically and dynamically generate the optimal ad network distribution without human intervention.

34. The media of claim 25, wherein each ad request is for an ad to be inserted into target content of a particular Web or WAP site, each site comprising one or more corresponding pages, each page comprising one or more spots for displaying an ad, wherein ones of the spots are grouped into spot groups, and wherein the one or more optimization factors are tailored for a particular spot group.
